(19) United States
(12) Patent Application Publication
(10) Pub. No.: US 2008/0133116 A1
(43) Pub. Date: Jun. 5, 2008

(54) SYSTEM, METHOD, AND COMPUTER SOFTWARE CODE FOR CONTROLLING ENGINE WARM-UP OF A DIESEL POWERED SYSTEM

(76) Inventors: James Robert Mischler, Lawrence Park, PA (US); Kyle Craig Stott, Erie, PA (US); Rekha D. Prasad, Sewickley, PA (US); Purvi Janani Limaye, Brentwood (GB); Samuel L. Hazen, Mayville, NY (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/950,424

(22) Filed: Dec. 4, 2007

Related U.S. Application Data
(60) Provisional application No. 60/868,588, filed on Dec. 5, 2006.

(51) Int. Cl. F02D 41/06

(52) U.S. Cl. 701/113; 123/350; 701/103

(57) ABSTRACT

A system for warming up an engine at an accelerated rate, the system including a control system configured to regulate at least one of a rotational speed and a horsepower load of the engine, a processor configured to evaluate a reading from the control system, and wherein the processor is further configured to adjust at least one of a rotational speed set point and/or a reference to engine speed regulator so that the engine may operate at an increased rotational speed without exceeding a predefined oil pressure limit. A method and a computer software code are also disclosed for warming up an engine at an accelerated rate.

### CROSS-REFERENCE TO RELATED APPLICATIONS

The present application claims priority based on U.S. Provisional Application No. 60/868,588 filed Dec. 5, 2006, which is incorporated herein by reference.

### BACKGROUND OF THE INVENTION

The field of invention relates to a diesel powered system, such as a train, off highway vehicle, marine system, and/or a stationary diesel powered system and, more specifically, for a system, method, and computer software code for warming up a diesel engine from a cold start.

Diesel powered systems such as, but not limited to, off-highway vehicles, marine diesel powered propulsion plants (or marine vessels), stationary diesel powered systems and rail vehicle systems (or trains), usually are powered by a diesel power unit. With respect to rail vehicle systems, the diesel power unit is part of at least one locomotive and the train further includes a plurality of rail cars, such as freight cars. Usually more than one locomotive is provided wherein the locomotives are collectively considered a locomotive consist. Locomotives are complex systems with numerous subsystems, with each subsystem being interdependent on other subsystems.

A typical type of diesel engine used in a diesel powered unit is a fuel injected diesel internal combustion engine. As a piston moves upward within a cylinder of a diesel engine, the air within the cylinder is compressed and heated. Fuel is injected into the combustion chamber as the piston nears its top dead center position. The fuel combusts with the compressed air, thereby providing energy for driving the engine and locomotive. There are many variables affecting the performance of a diesel engine, including the compression ratio, size of intake and exhaust valve openings, timing and duration of fuel injection, geometry of the combustion chamber, and peak temperature of the combustion gasses.

Lubricating oil typically used in a diesel engine has a viscosity that is strongly related to the temperature of the oil. When the diesel engine is equipped with a positive displacement oil pump, the pressure in the engine generally increases as the oil temperature decreases. Most diesel engines are usually equipped with mechanically driven positive displacement oil pumps. In these diesel engines the oil pressure is usually a function of engine speed.

When the engine goes through a warm-up, such as after a cold start, or where the engine typically after the engine has not operated for a number of hours and/or in less than ideal weather (cold weather), the oil pressure is usually higher than when at normal operating conditions. Situations have arisen where this pressure is at a high enough level to damage the diesel engine during a cold start if the engine is operated at too high of a speed initially, if no other actions are taken.

At least three approaches are known to address oil temperature issues at startup from a cold start. One approach is to add a large relief valve to the oil system. A drawback to this approach however is the additional cost associated with adding the large relief valve. An additional drawback of the large relief valve is that too much oil flow may be bypassed. Another approach is to place a limit on the diesel engine speed until the oil temperature has increased to normal, or acceptable, levels. A drawback to this approach is that a long wait time may be required for the engine to warm-up. The third approach is to have additional hardware for the sole purpose of maintaining engine oil temperature near an operational level temperature while the engine is shut down. This approach is cost prohibitive.

Thus, owners and operators of systems, such as but not limited to railway vehicles, off-highway vehicles, marine diesel powered propulsion plants, and/or stationary diesel powered systems, that utilize diesel internal combustion engines would benefit from a system and method that allows the diesel engine to run at the highest speed possible without exceeding any predefined oil pressure limits of the diesel engine during warm-up cycles while not resulting in prohibitive costs.

### BRIEF DESCRIPTION OF THE INVENTION

Embodiments of the invention disclose a system, method, and computer software code for warming up a diesel engine at an accelerated rate when compared to a normal time required to warm-up the diesel engine. A system for warming up diesel engine during a cold start is disclosed. The system has a control system configured to regulate at least one of a rotational speed and a horsepower load of the engine. A processor configured to evaluate a reading from the control system is further disclosed. The processor is further configured to adjust at least one of a rotational speed set point and/or a reference to engine speed regulator so that the engine may operate at an increased rotational speed without exceeding a predefined oil pressure limit.

In another exemplary embodiment another system for warming up a diesel engine at an accelerated rate is disclosed. The system includes a sensor configured to determine at least one of engine oil temperature, oil pressure, and rotational speed of the engine, and a processor configured to evaluate a reading from the sensor. The processor adjusts at least one of the rotational speed set point of the engine and/or a reference to a speed regulator of the engine to allow the engine to operate up to a highest rotational velocity without exceeding a predefined oil pressure limit.

In yet another exemplary embodiment, a method for warming up the engine at an accelerated rate is disclosed. The method includes determining engine oil temperature, and a step for determining engine oil pressure The method further provides for determining a rotational speed of the engine, and adjusting at least one of the engine rotational speed set point and reference to the engine speed regulator based on at least one of engine oil temperature and/or engine oil pressure.

A computer software code is disclosed, in another exemplary embodiment, which is storable on a computer readable media and operable on a processor for warming up the diesel engine at an accelerated rate. The computer software code includes a computer software module for determining engine oil temperature, and computer software module for determining engine oil pressure. A computer software module for determining a rotational speed of the engine is further disclosed. A computer software module is also disclosed for adjusting at least one of the engine rotational speed set point and/or reference to the engine speed regulator based on at least one of engine oil temperature and/or engine oil pressure.

In yet another exemplary embodiment a method for warming up the diesel engine at an accelerated rate is disclosed. The method includes determining a maximum allowable speed set point of an engine at a given condition based on at least one of a current oil pressure, oil temperature, and actual speed, and prohibiting the engine from exceeding a maximum pre-defined oil limit pressure. This method also discloses controlling the engine speed through fuel control, and determining a power reference to prevent overloading during engine warm-up is also disclosed.

### BRIEF DESCRIPTION OF THE DRAWINGS

A more particular description of exemplary embodiments of the invention briefly described above will be rendered by reference to specific embodiments thereof that are illustrated in the appended drawings. Understanding that these drawings depict only typical embodiments of the invention and are not therefore to be considered to be limiting of its scope, the exemplary embodiments of the invention will be described and explained with additional specificity and detail through the use of the accompanying drawings in which:

FIG. 1 depicts a block diagram of an exemplary embodiment of a system for warming up an engine at an accelerated rate;

FIG. 2 depicts an exemplary model for maximum oil pressure that may be operable within an algorithm for warming up an engine at an accelerated rate;

FIG. 3 depicts an exemplary embodiment of a flow chart for warming up an engine;

FIG. 4 depicts another exemplary embodiment of a flow chart for warming up an engine; and

FIG. 5 depicts an exemplary embodiment of a compound graph illustrating oil temperature, power, and engine speed versus time where a graphical representation resulting from an embodiment of the invention is compared to a graphical representation resulting from a prior art system.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

Though exemplary embodiments of the present invention are described with respect to rail vehicles, specifically trains and locomotives having diesel engines, exemplary embodiments of the invention are also applicable for other uses, such as but not limited to off-highway vehicles, marine vessels, and stationary units, each which may use a diesel engine. Therefore, with respect to railway, marine or off-highway vehicle applications embodiments of the invention may be used when diesel engines are used for the movement of the system from a present location to a destination. In the case of stationary applications, such as but not limited to a stationary power generating station or network of power generating stations, diesel engines may be used to produce an amount of wattage (e.g., MW/hr) or other parameters or requirement to be satisfied by the diesel powered system.

Exemplary embodiments of the present invention solve the problems in the art by providing a system, method, and computer software code, for warming up a diesel engine from a cold start. Persons skilled in the art will recognize that an apparatus, such as a data processing system, including a CPU, memory, I/O, program storage, a connecting bus, and other appropriate components, could be programmed or otherwise designed to facilitate the practice of the method of an exemplary embodiment of the invention. Such a system would include appropriate program means for executing the method.

Broadly speaking, the technical effect is warming up a diesel engine from a cold start at an accelerated rate by operating the diesel engine at a high speed while not exceeding a predefined oil pressure limit. Embodiments of the invention may be described in the general context of computer-executable instructions, such as program modules, being executed by any device, such as but not limited to a computer, designed to accept data, perform prescribed mathematical and/or logical operations usually at high speed, where results of such operations may or may not be displayed. Generally, program modules may include routines, programs, objects, components, data structures, etc., that perform particular tasks or implement particular abstract data types. For example, the software programs that underlie an embodiment of the invention may be coded in different programming languages, for use with different computing platforms. Examples of the invention may be implemented in the context of a web portal that employs a web browser. It will be appreciated, however, that the principles that underlie embodiments of the invention can be implemented with other types of computer software technologies as well.

Moreover, those skilled in the art will appreciate that embodiments of the invention may be practiced with other computer system configurations, including multiprocessor systems, minicomputers, and the like. Depending on system configuration, embodiments of the invention may also be practiced in distributed computing environments where tasks are performed by remote processing devices that are linked through a communications network. In a distributed computing environment, program modules may be located in both local and remote computer storage media including memory storage devices. For example a plurality of microprocessors on a locomotive may be used.

Also, an article of manufacture, such as a pre-recorded disk, computer readable media, or other similar computer program product, for use with a data processing system, could include a storage medium and program means recorded thereon for directing the data processing system to facilitate the practice of a method of an exemplary embodiment of the invention. Such apparatus and articles of manufacture also fall within the spirit and scope of embodiments of the invention.

Utilizing embodiments of the invention allows for diesel engines to initially operate at higher speeds, such as but not limited to highest rotational speeds possible for a given diesel engine, without exceeding a predefined oil pressure limit during warm-up cycles, even from a cold start. Not only is this function accomplished at a faster rate, since additional mechanical parts are not required, embodiments of the invention are performed at a lower cost.

Exemplary embodiments of the invention can be implemented in numerous ways, including as a system (including a computer processing system), a method (including a computer implemented method), an apparatus, a computer readable medium, a computer program product, a graphical user interface, including a web portal, or a data structure tangibly fixed in a computer readable memory. Several embodiments of the invention are discussed below.

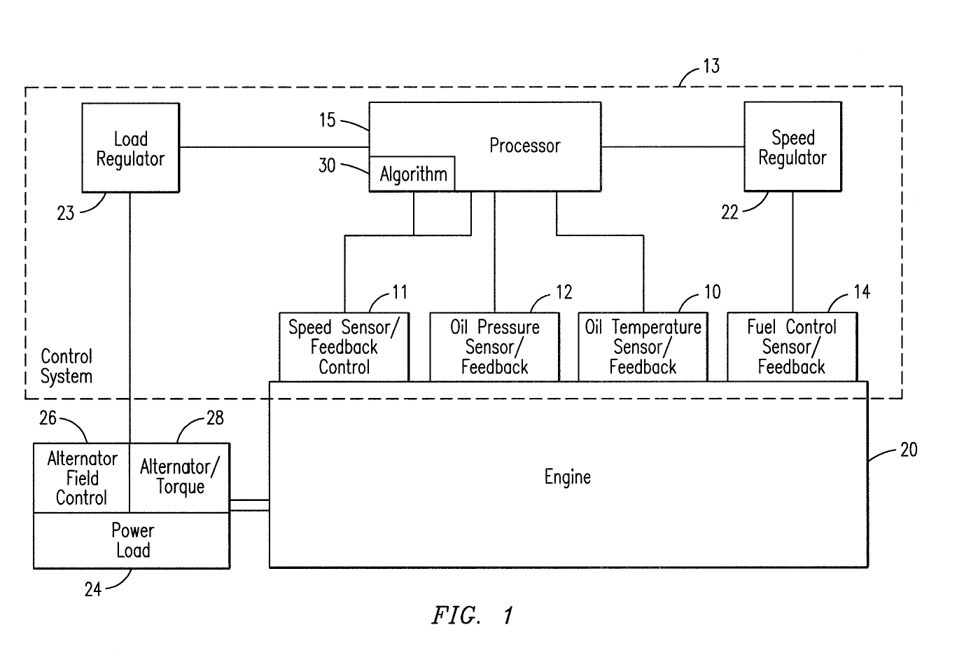

FIG. 1 depicts an exemplary embodiment of elements of a system for warming up a diesel engine from a cold start. As illustrated, sensors 10, 11, 12 are provided. In one exemplary example, the sensors 10, 11, 12 may be part of a control system 13 that may regulate rotational speed and/or load power of the diesel engine 20. The first sensor/feedback control 10 is configured to determine engine oil temperature. The second sensor/feedback control 11 is configured to determine rotational speed of the engine. The third sensor/feedback control 12 is configured to determine oil pressure. Though three sensors are disclosed, those skilled in the art will readily recognize that a single sensor may be used to determine each of these engine operating parameters. Furthermore, the sensors may be in communication with the control system 13 either via wires and/or through a wireless system.

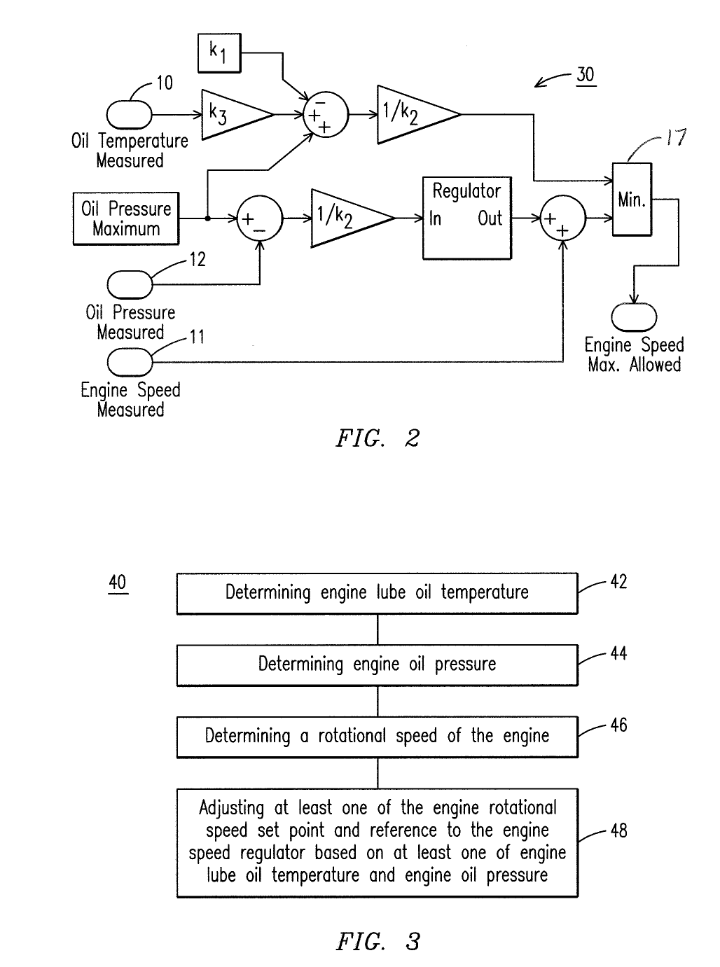

An engine management system 15, such as but not limited to a processor, is also provided. A warm-up strategy algorithm 30 functions with the processor 15 to determine a maximum allowable speed set point at a given condition based on at least one of current oil pressure such as measure by the third sensor 12, oil temperature such as measured by the first sensor 10, and/or actual speed such as measured by the second sensor 11, while not exceeding a maximum pre-defined oil pressure limit. Exemplary equations and additional information about the algorithm 30 are disclosed herein with reference to FIG. 2.

The algorithm 30 further is able to establish a speed reference that is provided to a speed regulator 22, which in turn controls the speed of the engine by controlling fuel provided to the engine 20, such as through a fuel control sensor/feedback control 14. During a warm-up sequence, the algorithm 30 also is able to establish at least one of a reference power and/or a reference torque applied to a load regulator 23 which is used to prevent overloading of the engine, such but not limited to where the engine is damaged during a cold start if the engine is operated at too high of a speed initially. The load regulator 23 is able to control the power load to the engine driven component, such as but not limited to controlling a field current provided to an alternator field regulator (or control) 26 or alternator/torque 28 provided to a power load 24, such as but not limited to a variable pitch propeller regulator, depending on specific type of application. By making such adjustments, the engine 20 may be operated at higher speeds than typically allowed based on a predefined oil pressure limit. Thus, the processor 15 is determining a power application of the engine 20 to prevent overloading during engine warm-up.

FIG. 2 depicts an exemplary model for maximum oil pressure as may be a part of the algorithm 30. More specifically FIG. 2 depicts function that allows for an engine, such as a diesel engine, to operate at its maximum speed without exceeding a maximum oil pressure, typically when the engine is cold or has not operated after a given period during which the engine has cooled to a constant pre-operating temperature state. Regulating the power application may be accomplished through a closed form mathematical function relating the maximum allowable rotational speed to outputs from the sensors. More specifically the processor 15 that regulates the power application of the engine 20 may further regulate a maximum allowable rotational speed relative to a sensed signal. In another example, a speed regulator 22 is used, which has its reference signal set to a predefined oil pressure limit. A relationship of oil pressure to engine speed and oil temperature is as follows:

Oil_pressure=k₁+k₂*engine_speed−k₃*oil_temperature, where k₁, k₂, and k₃ are regression constants that define the relationship of oil pressure to other parameters, such as but not limited to engine speed and oil temperature.

The maximum engine speed may be determined based on an equation. Two such exemplary equations are:

Engine_speed_maximum=engine_speed_measured+(oil_pressure_max−oil_pressure_measured)/k₂; and (1)

Engine_speed_maximum=(oil_pressure_maximum+k₃*oil_temperature_measured−k₁)/k₂. (2)

As disclosed above, Equation (1) may be provided to the speed regulator 22. As further illustrated in FIG. 2, a process to compare the resulting speed calculations is provided wherein the lower speed is selected as the engine speed maximum allowed. In an exemplary example, this process is performed in a mini-processor 17. Those skilled in the art will readily recognize that this process may be performed through other embodiments as well. Other exemplary examples include, but are not limited to, adjusting a signal, such as but not limited to a feedback signal to equal to the oil pressure, and/or controlling an output control variable of the reference speed. These exemplary examples may be implemented through the processor 15 and/or algorithm 30.

FIG. 3 depicts an exemplary embodiment of a flow chart that for warming up a diesel engine 20 from a cold start. As illustrated, the flow chart 40 illustrates determining engine oil temperature at 42. Additionally the method includes determining engine oil pressure at 44, and determining a rotational speed of the engine at 46. The method further includes adjusting the engine rotational speed set point and/or reference to the engine speed regulator based on engine oil temperature and/or engine oil pressure at 48. By using these steps the engine is able to operate at a higher rotational speed while not exceeding the predefined oil pressure limits. As disclosed above, the flow chart 40 may be implemented using a computer software code. The computer software code may reside on a computer readable media.

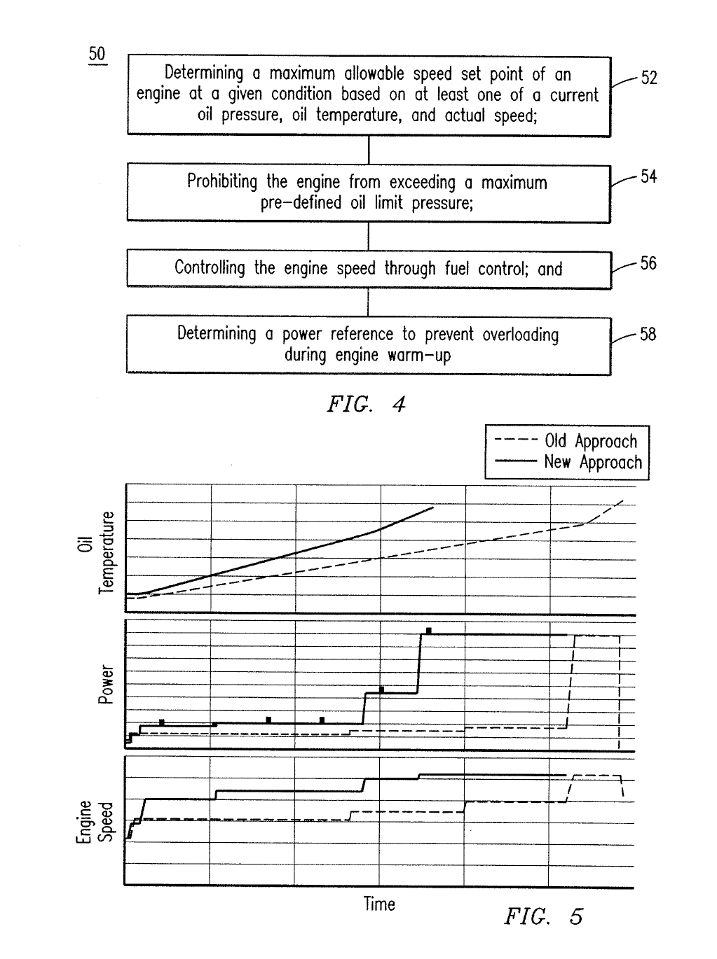

FIG. 4 depicts another exemplary embodiment of a flow chart for warming up a diesel engine 20 from a cold start. The flow chart 50 illustrates determining a maximum allowable speed set point of an engine at a given condition based on at least one of a current oil pressure, oil temperature, and actual speed at 52. Additionally the method provides for prohibiting the engine from exceeding a maximum pre-defined oil limit pressure at 54. The method further provides for controlling the engine speed through fuel control is further disclosed at 56. The method also discloses determining a power reference to prevent overloading during engine warm-up at 58. As disclosed above, this flow chart 50 may be implemented using a computer software code where the computer software code may reside on a computer readable media.

FIG. 5 depicts an exemplary embodiment of a compound graph illustrating oil temperature, power, and engine speed versus time where a graphical representation resulting from an embodiment of the invention is compared to a graphical representation resulting from a prior art system. As illustrated oil temperature, power, and engine speed increases at a quicker, or accelerated, rate using the exemplary systems, methods, and computer software codes (or collectively new approach) disclosed above when compared to prior art systems (or old approach).

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for warming up an engine at an accelerated rate, the system comprising:
a control system configured to regulate at least one of a rotational speed and a power load of the engine;
a processor configured to evaluate a reading from the control system; and
wherein the processor is further configured to adjust at least one of a rotational speed set point and a reference to engine speed regulator so that the engine may operate at an increased rotational speed without exceeding a predefined oil pressure limit.

2. The system according to claim 1, wherein the engine is a part of a power system for at least one of a railway vehicle system, a marine vessel, an off-highway vehicle, a stationary power generating station, and a network of stationary power generating stations.

3. The system according to claim 1, further comprises at least one sensor that is in communication with the processor and that is configured to determine at least one of engine oil temperature, oil pressure, and rotational speed of the engine.

4. The system according to claim 1, wherein the processor is further configured to adjust at least one of the rotational speed set point and the reference to engine speed regulator based on at least one of engine oil temperature, oil pressure, and rotational speed of the engine.

5. The system according to claim 1, wherein the processor regulates a power application of the engine to prevent overloading.

6. The system according to claim 1, wherein the control system comprises a sensor configured to determine at least one of engine oil temperature, oil pressure, and rotational speed of the engine.

7. The system according to claim 1, wherein the control system comprises a load regulator configured to control a power of the engine by at least one of adjusting a reference power to an alternator field regulator and adjusting a reference torque to a variable pitch propeller regulator, depending on an application of the engine.

8. The system according to claim 1, wherein the control system comprises a speed regulator configured to control engine speed through fuel control.

9. A system for warming up an engine at an accelerated rate, the system comprising:
a sensor configured to determine at least one of engine oil temperature, oil pressure, and rotational speed of the engine;
a processor configured to evaluate a reading from the sensor; and
wherein the processor is further configured to adjust at least one of the rotational speed set point of the engine and a reference to a speed regulator of the engine to allow the engine to operate up to a highest rotational velocity without exceeding a predefined oil pressure limit.

10. The system according to claim 9, further comprises the processor controlling a power load of the engine by at least one of adjusting a reference power to an alternator field regulator and adjusting a reference torque to a variable pitch propeller regulator depending on an application of the engine.

11. The system according to claim 9, wherein the processor regulates a power application of the engine to prevent overloading during engine warm-up.

12. The system according to claim 11, wherein the processor that regulates the power application of the engine further regulates a maximum allowable rotational speed relative to a sensed signal, through at least one of a regulator having a reference signal set to a predefined oil pressure limit, a feedback signal equal to measured oil pressure, and output control variable of reference engine speed.

13. The system according to claim 9, wherein the engine is a part of a power system for at least one of a railway vehicle system, a marine vessel, an off-highway vehicle, a stationary power generating station, and a network of stationary power generating stations.

14. A method for warming up an engine at an accelerated rate, the method comprising:
determining engine oil temperature;
determining engine oil pressure;
determining rotational speed of the engine; and
adjusting at least one of the engine rotational speed set point and reference to the engine speed regulator based on at least one of engine oil temperature and engine oil pressure.

15. The method according to claim 14, further comprises controlling a power load of the engine by adjusting at least one of a reference power to an alternator field regulator and a reference torque to a variable pitch propeller regulator depending on an application of the engine.

16. The method according to claim 14, further comprises determining an allowable rotational speed the engine may operate without exceeding a predefined oil pressure limit.

17. The method according to claim 15, further comprises regulating a power application of the engine to prevent overloading during warm-up.

18. The method according to claim 16, wherein the method is performed in the engine that is a part of a power system for at least one of a railway vehicle system, a marine vessel, an off-highway vehicle, a stationary power generating station, and a network of stationary power generating stations.

19. A computer software code storable on a computer readable media and operable on a processor for warming up an engine at an accelerated rate, the computer software code comprising:
computer software module for determining engine oil temperature;
computer software module for determining engine oil pressure;
computer software module for determining a rotational speed of the engine; and
computer software module for adjusting at least one of the engine rotational speed set point and reference to the engine speed regulator based on at least one of engine oil temperature and engine oil pressure.

20. The computer software code according to claim 19, further comprises a computer software module for controlling a power load of the engine by adjusting at least one of a reference power to an alternator field regulator and a reference torque to a variable pitch propeller regulator depending on an application of the engine.

21. The computer software code according to claim 19, further comprises a computer software module for determining an allowable rotational speed the engine may operate without exceeding a predefined oil pressure limit.

22. The computer software code according to claim 19, further comprises a computer software module for regulating a power application of the engine to prevent overloading during warm-up.

23. The computer software code according to claim 19, wherein the computer software code is used with the engine that is a part of a power system for at least one of a railway vehicle system, a marine vessel, an off-highway vehicle, a stationary power generating station, and a network of stationary power generating stations.

24. A method for warming up an engine at an accelerated rate, the method comprising:
determining a maximum allowable speed set point of an engine at a given condition based on at least one of a current oil pressure, oil temperature, and actual speed;
prohibiting the engine from exceeding a maximum pre-defined oil limit pressure;
controlling the engine speed through fuel control; and
determining a power reference to prevent overloading during engine warm-up.
